(19) United States
(12) Patent Application Publication
(10) Pub. No.: US 2016/0263874 A1
(43) Pub. Date: Sep. 15, 2016

(54) AQUEOUS SOLUTION-ABSORBING MAT

(71) Applicant: Plant-Sorb LLC, Floral Park, NY (US)

(72) Inventors: Yue CAI, Hangzhou (CN); Zengshen CAI, Hangzhou (CN); Gregory PIPPO, New York, NY (US); Charles RICK, Old Westbury, NY (US)

(21) Appl. No.: 14/929,573

(22) Filed: Nov. 2, 2015

(30) Foreign Application Priority Data
Mar. 13, 2015 (CN) 2015 2 0144929

(51) Int. Cl. B32B 27/12; B32B 27/32; B32B 3/26; B32B 38/04; B32B 38/00; B32B 5/02; B32B 37/06

(52) U.S. Cl. CPC B32B 27/12; B32B 5/024; B32B 27/32; B32B 37/065; B32B 38/04; B32B 38/0004; B32B 38/145; B32B 3/266; B32B 2038/042; B32B 2307/726; B32B 2262/0253; B32B 2323/046; B32B 2471/04

(57) ABSTRACT

A mat for absorbing aqueous solutions has a liquid-impervious bottom layer and a top fabric layer bonded directly to the bottom layer. The fabric layer is of needle punched polypropylene while the bottom layer is of low density polyethylene. The edges of the mat are heat die-cut to provide a moisture-impervious periphery for the mat.

The present invention relates to the mechanical arts, and in particular to a pad construction adapted to absorb liquids, such as water, and thus prevent damage to surfaces which may otherwise be exposed to such liquids. The pad has particular value as an absorbent pet mat to prevent soiling of surfaces by pet urination or excrement.

### BACKGROUND OF THE INVENTION

Particularly around the home, protection against inadvertent spillage and leakage of water and other liquids is of significant interest. Particularly with pets, it is of vital concern to the homeowner that pet urine and excrement not contact the floor or other surfaces. Conventional pet incontinence pads and mats utilize a cellulose or cotton fiber layer. The layer is treated with a water-absorbent polymer (SAP) to provide the needed water-retention. However, when absorbed, the SAB becomes irreversibly solidified and adheres to the cellulose or cotton. The pad thus has to be disposed of.

### BRIEF DESCRIPTION OF THE INVENTION

It is accordingly a purpose of the present invention to provide a pet incontinence mat or pad that does not rely upon a SAP and thus can be of economical manufacture and able to be reused. The present invention provides a highly absorbent fabric mat capable of retaining a relatively large volume of water relative to its size and thickness without the use of embedded chemicals. The mat comprises a non-woven polypropylene fabric layer bonded to a polyethylene bottom layer that provides a non-skin and liquid impermeable barrier, allowing liquid absorbed by the top layer to be retained by the layer and not migrate through the bottom layer to the floor or other surface on which the mat is placed. The polypropylene layer provides for liquid absorption and retention without the need for an SAP additive.

### DESCRIPTION OF THE DRAWING

FIG. 1 is a diagrammatic exploded view of a mat of the present invention.

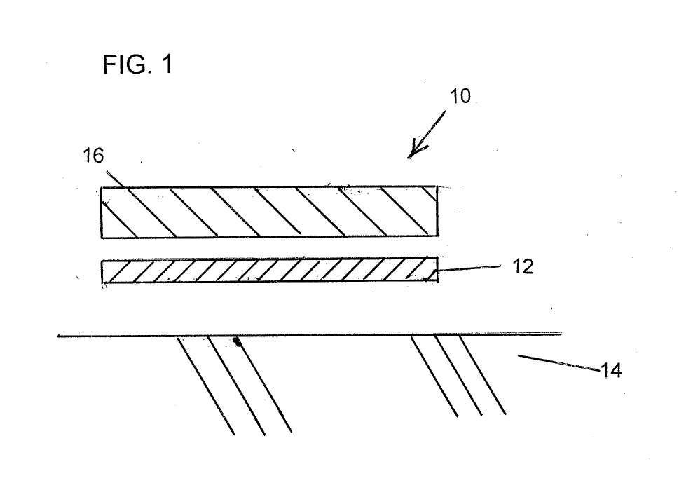

### DETAILED DESCRIPTION OF THE INVENTION

As illustrated in the Figure, a mat construction 10 of the invention includes a protective bottom sheet 12, constructed of polyethylene, preferably having a thickness of between 0.01 and 0.50 mm, and preferably between 0.08 and 0.12 mm and having a weight of 60 g/m². It serves as a base surface for the mat, is impervious to water and other liquids, and thus prevents the fluid being absorbed by the mat from reaching the surface 14 upon which the mat is placed, such as a floor.

Top liquid-absorbing layer 16 overlies the sheet 12. The layer is of a non-woven polypropylene fiber fabric, having a thickness of from 1.0 to 50 mm, and preferably in the range of 3 mm with a weight of 300 g/m². The upper surface of the layer may be imprinted with a design to make the mat more attractive in use.

The non-woven fabric for the liquid-absorbing layer 16 is formed by a needle punching process as known in the art. The needle punching process, in addition to interconnecting the mat fibers into a fabric, forms air spaces to accept and retain moisture while forming a flexible and durable web. Typically, the fabric batt will be on the order of 150 cm width. The batt is then cut to a convenient length for further processing.

After the fabric layer batt and cut to length is formed it is heat ironed at a temperature of 100-120° C. The temperature is chosen to soften the surface fibers without causing melting. The softened fibers shrink and adhere to each other, forming a flattened surface to provide a proper print-receptive substrate. The lower fibers retain the netted structure, retaining the air spaces to accept moisture. While the upper surface is print-acceptable, it still allows moisture to penetrate to reach the inner fiber matrix.

After the ironing process a desired design may be applied to the layer by use of a digital spraying process as known in the art. The liquid-absorbing layer is then bonded to the low-density polyethylene sheet 12 by a heat seal process as known in the art, which includes heating and pressing stages. In addition to bonding the layers together, the mat is further flattened and the printing made color-fast.

The finished mat structure is then heat die cut into the desired finished sizes, The die cut process seals the edges, preventing absorbed moisture from migrating out through the edges.

The die cut mat may be of any shape desired, although a preferred shape is square or rectangular in ranges from 5×5 cm to 20×20 cm. for use a pet mat. Other contemplated sizes may range from 45×30 cm to 122×74 cm.

We claim:

1. A mat for absorbing aqueous solutions, comprising a liquid-impervious low density polyethylene layer and an absorbent polypropylene needle punched heat ironed fabric layer overlying and directly heat-bonded to the bottom sheet without the presence of any moisture absorbent therebetween, the edges of the mat being formed by a heat die-cutting process to provide a moisture-impervious peripheral seal.

2. The mat of claim 1 further comprising a print layer applied to a top surface of the fabric layer.

3. The mat of claim 2 wherein the fabric layer has a weight of about 300 grams per square meter.

4. The mat of claim 2 wherein the polyethylene layer has a weight of about 60 grams per square meter.

5. A method for forming a aqueous solution-absorbing mat, comprising the steps of:
forming a polypropylene fabric batt using needle punching;
heat ironing the batt to soften and bind surface fibers while retaining a needle punch structure for internal fibers;
optionally printing design on a top surface of the batt;
laminating the batt to a bottom layer of low density polyethylene whereby the lamination is flattened and any printed design is made color-fast; and
dye-cutting the lamination to a finished size whereby cut edges of the finished size are made moisture-impervious.

6. The process of claim 5 wherein the formed polypropylene batt has a weight of about 300 grams per square meter.

7. The process of claim 5 wherein the batt softening and binding step is performed at a temperature of 100-120 degrees C.
